(19) United States
(12) Patent Application Publication
(10) Pub. No.: US 2025/0131449 A1
(43) Pub. Date: Apr. 24, 2025

(54) Systems and Methods of Customer Appeasement Control System

(71) Applicant: Blue Yonder Group, Inc., Scottsdale, AZ (US)

(72) Inventors: Priyanka Koushik, Irving, TX (US); Gaurav Kumar, Carrollton, TX (US); Dushyanth Karumani, Bangalore (IN); Raghuveer Prasad Nagar, Kota (IN)

(21) Appl. No.: 18/799,593

(22) Filed: Aug. 9, 2024

Related U.S. Application Data
(60) Provisional application No. 63/545,467, filed on Oct. 24, 2023.
(60) Provisional application No. 63/547,784, filed on Nov. 8, 2023.
(60) Provisional application No. 63/547,782, filed on Nov. 8, 2023.

(51) Int. Cl. G06Q 30/016; G06Q 30/018

(52) U.S. Cl. CPC G06Q 30/016; G06Q 30/0185

(57) ABSTRACT

A system and method are disclosed for validating an appeasement request. The method includes determining an appeasement request pattern for a customer, determining an appeasement application pattern for a customer service representatives assigned to the customer, mining data associated with the appeasement request, mining other data associated with the customer or the customer service representatives, and validating an appeasement request based on the mined data and the mined other data. The method further includes determining that an association between the customer service representatives and a group of customers indicates one or more fraudulent appeasement requests, where the appeasement application pattern is based on a history of appeasements offered to one or more customers and where validating the appeasement request further comprises limiting an appeasement offer associated with the appeasement request.

### CROSS-REFERENCE TO RELATED APPLICATIONS

The present disclosure is related to that disclosed in the U.S. Provisional Application No. 63/545,467, filed Oct. 24, 2023, entitled “Cognitive Appeasement Recommendations,” U.S. Provisional Application No. 63/547,784, filed Nov. 8, 2023, entitled “Determining the Impact of a Customer on Other Customers,” and U.S. Provisional Application No. 63/547,782, filed Nov. 8, 2023, entitled “Customer Appeasement Control System.” U.S. Provisional Application Nos. 63/545,467, 63/547,784, and 63/547,782 are assigned to the assignee of the present application. The present invention hereby claims priority under 35 U.S.C. § 119(e) to U.S. Provisional Application Nos. 63/545,467, 63/547,784, and 63/547,782.

### TECHNICAL FIELD

The present disclosure relates generally to supply chain logistics and more specifically to performing appeasement operations in a supply chain network.

### BACKGROUND

Enterprises often offer appeasements when customers are dissatisfied with ordering and commerce experiences, such as online or self-service portal experiences, customer service experiences, delivery or fulfillment experiences, and pricing experiences, among other ordering and commerce experiences. When existing appeasement systems discover such customer dissatisfaction, customer service teams offer appeasements that typically include discounts on orders or on charges to retain the dissatisfied customers. However, there are various scenarios in which appeasement policies or procedures of enterprises are abused. For example, a customer may frivolously or fraudulently report issues with orders, or a customer service representative may grant repeatedly grant appeasement requests that are frivolous or fraudulent. Existing appeasement situations fail to detect and accommodate for such abuses of appeasement policies and procedures, resulting in increased operating costs and lost revenue, both of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with a first embodiment;

FIG. 2 illustrates the appeasement control system, the archiving system, and the planning and execution system of FIG. 1 in greater detail, in accordance with an embodiment;

FIG. 3 illustrates a method for generating and presenting appeasement offers to customers of a supply chain network, in accordance with an embodiment;

FIG. 4 illustrates a method for generating appeasement offers based on validated appeasement requests, in accordance with an embodiment;

FIG. 5 illustrates an example method for detecting appeasement requests, in accordance with an embodiment;

FIG. 6 illustrates an example method for validating appeasement requests, in accordance with an embodiment;

FIG. 7 illustrates an example method for determining an appeasement allowance, in accordance with an embodiment; and

FIG. 8 illustrates an example method for presenting responses to appeasement requests, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are illustrated or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed invention may be applied. The full scope of the invention is not limited to the examples that are described below.

As described below, embodiments of the following disclosure provide systems and methods for validating appeasement requests in a supply chain network. Embodiments may, depending on customer data, including appeasement history and customer service interactions, determine to limit appeasement offers, determine appeasement allowances for customers, reject appeasement requests from customers or customer service representatives (CSRs), or reassign appeasement requests to different CSRs. Systems and methods disclosed herein may utilize machine learning (ML) or artificial intelligence (AI) techniques to determine appeasement offers to recommend based on customer data. Embodiments may also generate and present rationales for responses to appeasement requests.

Embodiments of the following disclosure enable operators of supply chains or individual sellers or retailers to limit the misuse of appeasement requests by customers by validating appeasement requests before taking any appeasement action. Use of embodiments may reduce losses of sales and customers, as well as increase customer loyalty. Use of embodiments may further improve appeasement performance for customers who may not be satisfied with simple discount offers or for customers who discontinue business with sellers without reporting negative order experiences by utilizing various data sources of customers, such as communications and interactions with sellers. Implementation of the systems and methods described herein may include the preregistration of users to data collection and processing services, such as tracking customer service interactions and social media interactions, to further protect user data privacy.

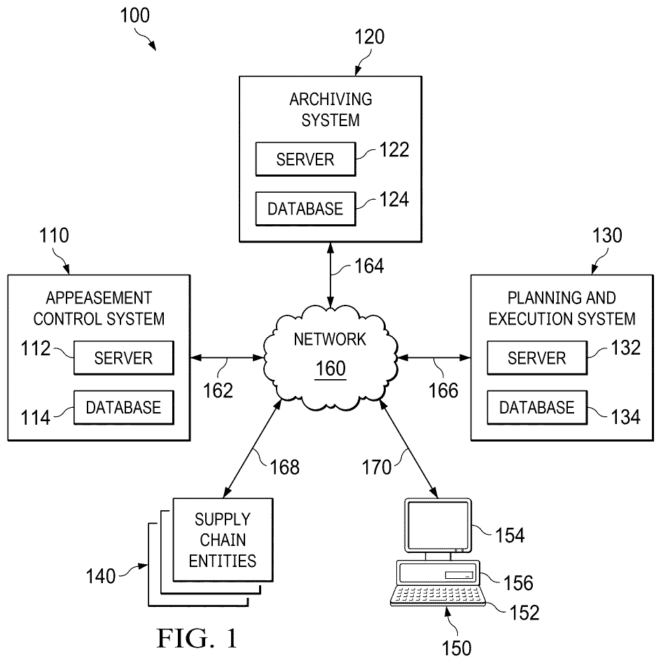

FIG. 1 illustrates supply chain network 100, in accordance with a first embodiment. Supply chain network 100 comprises appeasement control system 110, archiving system 120, planning and execution system 130, one or more supply chain entities 140, one or more computers 150, network 160, and one or more communication links 162-170. Although a single appeasement control system 110, a single archiving system 120, a single planning and execution system 130, one or more supply chain entities 140, one or more computers 150, a single network 160, and one or more communication links 162-170 are illustrated and described, embodiments contemplate any number of appeasement control systems, archiving systems, planning and execution systems, supply chain entities, computers, networks, or communication links, according to particular needs.

In one embodiment, appeasement control system 110 comprises server 112 and database 114. Although appeasement control system 110 is illustrated in FIG. 1 as comprising a single server 112 and a single database 114, embodiments contemplate appeasement control system 110 including any suitable number of servers, databases, serverless computing options, or data stores internal to, or externally coupled with, appeasement control system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs.

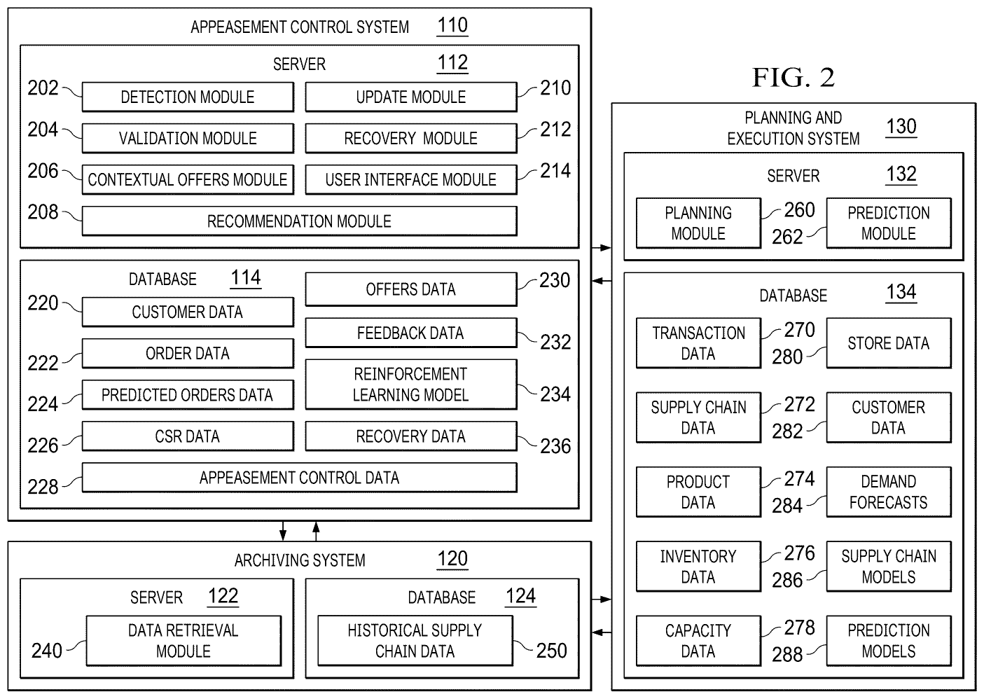

According to embodiments, appeasement control system 110 detects and validates appeasement requests placed by customers and CSRs. As described in further detail below, appeasement control system 110 may access various customer data 220 (FIG. 2) and CSR data 226 to validate appeasement requests received in connection with a particular order of supply chain network 100 or in connection with a particular customer of supply chain network 100. When appeasement control system 110 determines not to validate an appeasement request, appeasement control system 110 may initiate actions in response, such as rejecting appeasement requests and offering order modifications instead, among other options. Appeasement control system 110 may determine not to validate an appeasement request for various reasons, including abuse of an appeasement policy or procedure of a retailer, such as by repeatedly requesting appeasements for self-reported order problems. For example, when a particular customer has an established pattern of requesting appeasements on every placed order, appeasement control system 110 may set an appeasement allowance associated with an account of the customer to limit the overall expenditure on appeasements for the customer.

In embodiments, appeasement control system 110 also generates appeasement offers for the customer in response to validated appeasement situations. Upon validating the situation requiring customer appeasement, appeasement control system 110 may recommend one or more appeasement offers to present to the customer to resolve the situation such that customer satisfaction is maximized. Appeasement control system 110 may limit the one or more appeasement offers by an appeasement allowance set for the customer based on validation of the appeasement request. Once an appeasement situation has been detected, appeasement control system 110 may generate one or more appeasement offers tailored to the context of the appeasement situation and the customer value and may present one or more appeasement offers to the customer.

Archiving system 120 comprises server 122 and database 124. Although archiving system 120 is illustrated as comprising single server 122 and single database 124, embodiments contemplate any suitable number of servers or databases internal to, or externally coupled with, archiving system 120. Server 122 of archiving system 120 may support one or more processes for receiving and storing data from planning and execution system 130 and/or one or more computers 150 of supply chain network 100. According to some embodiments, archiving system 120 comprises an archive of data received from planning and execution system 130 and/or one or more computers 150 of supply chain network 100 and provides archived data to appeasement control system 110 and/or planning and execution system 130. Server 122 may store the received data in database 124, which may comprise one or more databases or other data storage arrangements at one or more locations local to, or remote from, server 122.

According to an embodiment, planning and execution system 130 comprises server 132 and database 134. Supply chain planning and execution is typically performed by several distinct and dissimilar processes, including, for example, strategic assortment planning, demand forecasting, planning, operations planning, production planning, supply planning, distribution planning, execution, pricing, forecasting, transportation management, warehouse management, inventory management, fulfillment, procurement, and the like. Server 132 of planning and execution system 130 comprises one or more modules, such as, for example, a sourcing module, a scheduling module, and/or a pick-pack-ship module for performing one or more order fulfillment processes. Server 132 stores and retrieves data from database 134 or one or more locations in supply chain network 100. In addition, planning and execution system 130 operates on one or more computers 150 that are integral to, or separate from, the hardware and/or software that support archiving system 120 and appeasement control system 110.

One or more supply chain entities 140 may represent one or more suppliers, one or more manufacturers, one or more distribution centers, and one or more retailers in one or more supply chain networks, including one or more enterprises. One or more suppliers may be any suitable entity that offers to sell or otherwise provides one or more items or components to one or more manufacturers or buyers. One or more suppliers may, for example, receive an item from a first supply chain entity of one or more supply chain entities 140 in supply chain network 100 and provide the item to another supply chain entity of one or more supply chain entities 140, which in some embodiments may be a buyer, a customer, or an end user. Items may comprise, for example, components, materials, products, parts, supplies, or other items that may be used to produce products. In addition, or as an alternative, an item may comprise a supply or resource that is used to manufacture the item but does not become a part of the item. In embodiments, items may comprise a service, such as an installation service. One or more suppliers may comprise automated distribution systems that automatically transport items to one or more manufacturers based, at least in part, on a supply chain plan having fair-shared items or resources, a material or capacity reallocation, current and projected inventory levels, and/or one or more additional factors described herein.

A manufacturer may be any suitable entity that manufactures at least one product. A manufacturer may use one or more items during the manufacturing process to produce any manufactured, fabricated, assembled, or otherwise processed item, material, component, good, or product. In one embodiment, a product represents an item ready to be supplied to, for example, another supply chain entity of one or more supply chain entities 140, such as a supplier, an item that needs further processing, or any other item. A manufacturer may, for example, produce and sell a product to a supplier, another manufacturer, a distribution center, a retailer, a customer, or any other suitable person or an entity. Such manufacturers may comprise automated robotic production machinery that produce products based, at least in part, on a supply chain plan having fair-shared items or resources, a material or capacity reallocation, current and projected inventory levels, and/or one or more additional factors described herein.

One or more distribution centers may be any suitable entity that offers to sell or otherwise distributes at least one product to one or more retailers and/or customers. Distribution centers may, for example, receive a product from a first supply chain entity of one or more supply chain entities 140 in supply chain network 100 and store and transport the product for a second supply chain entity of one or more supply chain entities 140. Such distribution centers may comprise automated warehousing systems that automatically transport products to one or more retailers or customers and/or automatically remove an item from, or place an item into, inventory based, at least in part, on a supply chain plan having fair-shared items or resources, a material or capacity reallocation, current and projected inventory levels, and/or one or more additional factors described herein.

One or more retailers may be any suitable entity that obtains one or more products to sell to one or more customers. In addition, one or more retailers may sell, store, and supply one or more components and/or repair a product with one or more components. One or more retailers may comprise any online or brick and mortar location, including locations with shelving systems. In some embodiments, one or more retailers may comprise a group of sellers, such as, for example, a shopping mall. Shelving systems may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location.

The same supply chain entity may simultaneously act as any one or more suppliers, manufacturers, distribution centers, and retailers. For example, one or more supply chain entities 140 acting as a manufacturer may produce a product, and the same entity may act as a supplier to supply a product to another supply chain entity of one or more supply chain entities 140. Although one example of supply chain network 100 is illustrated and described, embodiments contemplate any configuration of supply chain network 100 without departing from the scope of the present disclosure.

As illustrated in FIG. 1, supply chain network 100 comprising appeasement control system 110, archiving system 120, planning and execution system 130, and one or more supply chain entities 140 may operate on one or more computers 150 that are integral to, or separate from, the hardware and/or software that support appeasement control system 110, archiving system 120, planning and execution system 130, and one or more supply chain entities 140. One or more computers 150 may include any suitable input device 152, such as a keypad, mouse, touch screen, microphone, or other device to input information. Output device 154 may convey information associated with the operation of supply chain network 100, including digital or analog data, visual information, or audio information. One or more computers 150 may include fixed or removable computer-readable storage media, including a non-transitory computer-readable medium, magnetic computer disks, flash drives, CD-ROM, in-memory device, or other suitable media to receive output from and provide input to supply chain network 100.

One or more computers 150 may include one or more processors 156 and associated memory to execute instructions and manipulate information according to the operation of supply chain network 100 and any of the methods described herein. In addition, or as an alternative, embodiments contemplate executing the instructions on one or more computers 150 that cause one or more computers 150 to perform functions of the methods. An apparatus implementing special purpose logic circuitry, such as, for example, one or more field-programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations local to, or remote from, appeasement control system 110, archiving system 120, planning and execution system 130, and one or more supply chain entities 140. In addition, each of one or more computers 150 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with appeasement control system 110 and archiving system 120.

In one embodiment, appeasement control system 110 may be coupled with network 160 using more communication link 162, which may be any wireline, wireless, or other link suitable to support data communications between appeasement control system 110 and network 160 during operation of supply chain network 100. Archiving system 120 may be coupled with network 160 using communication link 164, which may be any wireline, wireless, or other link suitable to support data communications between archiving system 120 and network 160 during operation of supply chain network 100. Planning and execution system 130 may be coupled with network 160 using communication link 166, which may be any wireline, wireless, or other link suitable to support data communications between planning and execution system 130 and network 160 during operation of supply chain network 100. One or more supply chain entities 140 may be coupled with network 160 using communication link 168, which may be any wireline, wireless, or other link suitable to support data communications between one or more supply chain entities 140 and network 160 during operation of supply chain network 100. One or more computers 150 may be coupled with network 160 using communication link 170, which may be any wireline, wireless, or other link suitable to support data communications between one or more computers 150 and network 160 during operation of supply chain network 100. Although communication links 162-170 are illustrated as generally coupling appeasement control system 110, archiving system 120, planning and execution system 130, one or more supply chain entities 140, and one or more computers 150 to network 160, any of appeasement control system 110, archiving system 120, planning and execution system 130, one or more supply chain entities 140, and one or more computers 150 may communicate directly with each other, according to particular needs.

In another embodiment, network 160 includes the Internet and any appropriate local area networks (LANs), metropolitan area networks (MANs), or wide area networks (WANs) coupling appeasement control system 110, archiving system 120, planning and execution system 130, one or more supply chain entities 140, and one or more computers 150. For example, data may be maintained locally to, or externally of, appeasement control system 110, archiving system 120, planning and execution system 130, one or more supply chain entities 140, and one or more computers 150 and made available to one or more associated users of appeasement control system 110, archiving system 120, planning and execution system 130, one or more supply chain entities 140, and one or more computers 150 using network 160 or in any other appropriate manner. For example, data may be maintained in a cloud database at one or more locations external to appeasement control system 110, archiving system 120, planning and execution system 130, one or more supply chain entities 140, and one or more computers 150 and made available to one or more associated users of appeasement control system 110, archiving system 120, planning and execution system 130, one or more supply chain entities 140, and one or more computers 150 using the cloud or in any other appropriate manner. Those skilled in the art will recognize that the complete structure and operation of network 160 and other components within supply chain network 100 are not depicted or described. Embodiments may be employed in conjunction with known communications networks and other components.

FIG. 2 illustrates appeasement control system 110, archiving system 120, and planning and execution system 130 of FIG. 1 in greater detail, in accordance with an embodiment. Appeasement control system 110 may comprise server 112 and database 114, as described above. Although appeasement control system 110 is illustrated as comprising a single server 112 and a single database 114, embodiments contemplate any suitable number of servers or databases internal to, or externally coupled with, appeasement control system 110.

Server 112 of appeasement control system 110 comprises detection module 202, validation module 204, contextual offer module 206, recommendation module 208, update module 210, recovery module 212, and user interface module 214. Although server 112 is illustrated and described as comprising a single detection module 202, a single validation module 204, a single contextual offer module 206, a single recommendation module 208, a single update module 210, a single recovery module 212, and a single user interface module 214, embodiments contemplate any suitable number or combination of these located at one or more locations local to, or remote from, appeasement control system 110, such as on multiple servers or computers 150 at one or more locations in supply chain network 100.

In an embodiment, detection module 202 detects a situation requiring appeasement of a customer of supply chain network 100. As described in further detail below, to detect the situation requiring appeasement, detection module 202 may track interactions between the customer and one or more CSRs or other channels monitored by appeasement control system 110 and, using the tracked interactions, detect that the customer is dissatisfied and derive an appeasement reason. As used herein, a CSR may refer to both human representatives working in customer service as well as bots or other AI-enabled interfaces or programs that automatically respond to customer communications. In embodiments, detection module 202 also utilizes customer data 220, such as customer transaction data, to determine whether to offer appeasement to the customer. For example, detection module 202 may determine customers with low total transaction values or first-time customers to be less important for appeasement than customers with high total transaction values or long-standing customers. According to embodiments, detection module 202 also processes a manual or explicit request for appeasement, such as from a customer or a CSR, received by appeasement control system 110. As used herein, a CSR may refer to both human representatives working in customer service as well as chat bots or other AI-enabled interfaces or programs that automatically respond to customer communications. In embodiments, AI-enabled CSR chat bots may collect feedback data 232 to perform reinforcement learning to limit or eliminate bias from interactions with customers.

Validation module 204 validates manual appeasement requests and determines one or more actions to take in response, including, for example, approving appeasement requests, rejecting appeasement requests, setting appeasement allowances, recommending order modifications instead of appeasements, reassigning CSRs assigned to a certain customer, or other actions depending on the validation status of the appeasement request. In addition, or as an alternative, validation module 204 may validate appeasement situations automatically detected by detection module 202 and determine one or more actions to take in response to the detected appeasement situation. As discussed in further detail below, validation module 204 may analyze customer data 220, order data 222, and CSR data 226, including appeasement history and appeasement patterns of customers, customer clusters, and CSRs, to validate or reject a particular appeasement request or detected appeasement situation. Validation module 204 may also determine an appeasement allowance to apply to a particular appeasement request or detected appeasement situation. In embodiments, validation decisions and appeasement allowances may be used by one or more other modules of appeasement control system 110 in generating appeasement offers or recommending appeasement offers to users of appeasement control system 110. Validation module 204 may further synthesize a rationale for determined actions to take in response to appeasement requests, which may be presented to the customer, a CSR, or other user of appeasement control system via user interface module 214.

Contextual offers module 206 derives one or more contextual appeasement offers to offer to a customer of supply chain network 100. In embodiments, contextual offers module 206 generates in consideration of a validation decision made by validation module 204. For example, contextual offers module 206 may generate appeasement offers limited to an appeasement limit set by validation module 204. As described in further detail below, to generate the appeasement offers, contextual offers module 206 may access data associated with an order that has resulted in a situation requiring appeasement and an overall order history of the customer to determine a customer value. In embodiments, contextual offers module 206 predicts future orders of the customer and, based, at least in part, on the predicted future orders, determines the customer value. Contextual offers module 206 may further use the determined customer value and one or more AI or ML techniques to generate a set of appeasement offers for the customer along with a rationale for each appeasement offer. For example, when the appeasement situation is a late order delivery, contextual offers module 206 may determine, based on appeasement history for other late order situations, that discounts on future orders tend to be a poor appeasement (i.e., results in customer dissatisfaction) for such situations, while an immediate discount or partial refund of the current order tends to be a good appeasement (i.e., results in customer satisfaction) for such situations. In this example, contextual offers module 206 may generate an appeasement of a certain amount discounted from the current order with a rationale to present to a user of appeasement recommendation system 110 which summarizes the expected value of offering the discount appeasement compared to other appeasements.

Recommendation module 208 dynamically assigns a priority to one or more appeasement offers and recommends the one or more appeasement offers in order of the assigned priority. As described in further detail below, recommendation module 208 may generate recommendations for customer appeasements based, at least in part, on validation decisions made by validation module 204, such as recommending appeasement offers which may be capped at a certain value for certain customers or for certain CSRs. In addition, or as an alternative, recommendations for customer appeasements may also include recommendations to avoid appeasements, such as by offering order modifications, recommendations to reassign a particular appeasement request from one CSR to another, or other non-traditional appeasements. Recommendation module 208 may calculate acceptance scores for each appeasement offer generated by contextual offers module 206 representing a predicted likelihood of a customer accepting a particular appeasement offer. The acceptance scores may be based on, for example, appeasement history for similar customers or appeasement history for similar situations. According to embodiments, recommendation module 208 compares the calculated acceptance scores against a user approval threshold to determine whether approval of a user of appeasement control system 110 is required to offer the appeasement. In addition, or as an alternative, user approval may be required for any appeasements with a total value or cost above a certain threshold, such as large appeasements for important or business entity customers. Recommendation module 208 may also, via user interface module 214, present the appeasement offers to the customer in order of the calculated acceptance scores.

Update module 210 collects feedback from user responses and customer responses to improve future recommendations of appeasement offers. As described in further detail below, update module 210 tracks various actions of the user during a user approval process as feedback, such as acceptance of an appeasement offer recommendation, rejection of an appeasement offer recommendation, modifications made by the user to an appeasement offer recommendation, or user comments made on an appeasement offer recommendation. Update module 210 may also track various actions of the customer while presenting an appeasement offer to the customer, such as customer acceptance of an appeasement offer, customer rejection of an appeasement offer, or requests made by the customer to update an appeasement offer. Update module 210 may provide the collected feedback to reinforcement learning model 234 to iteratively update other modules of appeasement control system 110.

Recovery module 212 determines an entity that is responsible for an appeasement situation and automatically initiates a process to recover the cost of an appeasement offer accepted by a customer. As described in further detail below, recovery module 212 may use a reason for an appeasement situation, which in embodiments may be derived by detection module 202, to determine the entity that is responsible for the appeasement situation. In embodiments, a responsible entity may be a particular supply chain entity of one or more supply chain entities 140, a supply chain partner (e.g., a shipping or analytics partner), or any other entity not directly controlled by or within supply chain network 100. When an appeasement offer is accepted by a customer, recovery module 212 may further determine the total cost or recovery amount of the appeasement offer and automatically initiate a recovery process with the responsible entity.

User interface module 214 generates and displays a UI, such as, for example, a graphical user interface (GUI), that displays appeasement offers or any other data of appeasement control system 110 in charts, graphs, histograms, or any other visual representations. According to embodiments, user interface module 214 displays a GUI comprising interactive graphical elements for selecting one or more recommended appeasement offers and/or data of any kind stored in database 114 of appeasement control system 110 and, in response to the selection, displays the selected data on one or more display devices. In some embodiments, user interface module 214 presents a website or an application associated with a seller or a retailer to customers of supply chain network 100. In such embodiments, user interface module 214 may update user experiences associated with the website or the application based on customer impact and customer value determined by value module 204. For example, user interface module 214 may present messages to customers or alter or rearrange elements of GUIs of the website or application to update the user experience. In addition, or as an alternative, user interface module 214 may be based on non-visual channels, such as voice via a virtual assistant or the like, and present appeasement offers or synthesized rationales to customers over such non-visual channels. In embodiments, user interface module 214 presents a GUI enabling a customer to accept or reject an appeasement offer. User interface module 214 may also present a GUI enabling a user to approve or reject an appeasement offer before the offer is made to a customer. Acceptance or rejections of appeasement offers by customers and approvals or rejections of appeasement offers by users may be collected via user interface module 214 and tracked by update module 210 to be used as feedback for reinforcement learning to further improve appeasement control system 110.

Database 114 of appeasement control system 110 may comprise one or more databases or other data storage arrangements at one or more locations local to, or remote from server 112. Database 114 of appeasement control system 110 comprises, for example, customer data 220, order data 222, predicted orders data 224, CSR data 226, appeasement control data 228, offers data 230, feedback data 232, reinforcement learning model 234, and recovery data 236. Although database 114 of appeasement control system 110 is illustrated and described as comprising customer data 220, order data 222, predicted orders data 224, CSR data 226, appeasement control data 228, offers data 230, feedback data 232, reinforcement learning model 234, and recovery data 236, embodiments contemplate any suitable number or combination of data or machine learning models located at one or more locations local to, or remote from, appeasement control system 110, according to particular needs.

In an embodiment, customer data 220 comprises data associated with customers of supply chain network 100. Customer data 220 may include a purchase history, which may indicate a shopping pattern of a customer, an order modification history, and a cancellation history of the customer. Customer data 220 may also include customer inquiries, such as inquiries related to promotions of one or more supply chain entities 140 of supply chain network 100 or competitors of one or more supply chain entities 140. In embodiments, customer data 220 further comprises customer calendar data, social media data associated with customers, customer service interactions taking place after order placement, internet of things (IoT) data collected from IoT devices associated with customers, and customer profiles and preferences. Customer data 220 may also comprise customer interactions with customer service channels or self-service channels (e.g., call center interactions, website or app interactions, social media interactions, in-person interactions, email interactions, or any other interactions with customer service associated with supply chain network 100), various data related to groups of customers or all customers of supply chain network 100 (e.g., customer clusters or segments including a particular customer or any other grouping of customers based on similarity, customer profiles, customer preferences, or the like), and appeasement cost information associated with customers (e.g., return rates, order modification rates, and appeasement history, including success or failure of similar appeasement offers for similar customers or for customers ordering similar products or services). Customer data 220 may be used by detection module 202 to detect appeasement events for customers, by validation module 204 to validate appeasement requests, by contextual offers module 206 to generate and rank contextual appeasement offers, and by recommendation module 208 to compute acceptance scores for contextual appeasement offers.

Order data 222 comprises data of orders placed in supply chain network 100. According to embodiments, order data 222 includes products or services of an order, a time the order was placed, fulfillment options of the order (e.g., a picking time or shipping service), an address or physical location associated with delivery or fulfillment, items and a quantity thereof the order, order notes, total value of the order, and any other data which may be associated with a placed order. Order data 222 may be used by detection module 202 to detect appeasement events for customers and by contextual offers module 206 to generate and rank contextual appeasement offers.

Predicted orders data 224 comprises orders that a customer of supply chain network 100 is likely to place in the future. For example, contextual offers module 206 may predict future orders based on order history data, (e.g., when a customer places an order for a particular product on a regular basis), based on subscription data for the customer, or based on order patterns or order history of similar customers or customers within the same cluster or segment as the customer. In embodiments, contextual offers module 206 utilizes one or more AI or ML models to predict the likelihood or value of future orders by the customer. Predicted orders data 224 may be used by detection module 202 to detect appeasement events for customers and by contextual offers module 206 to generate and rank contextual appeasement offers.

CSR data 226 comprises any data related to CSRs of supply chain network 100. For example, CSR data 226 may include appeasement history data for CSRs, such as the number of times a CSR has offered appeasements to customers of supply chain network 100 and the value of any offered appeasements. In embodiments, the appeasement history data may be broken down by customer or customer cluster to determine appeasement offer rates and appeasement offer patterns by the CSR to particular customers or groups of customers. CSR data 226 may also include message data of interactions between a CSR and customers, which may be analyzed by validation module 204 using natural language processing (NLP) techniques to determine whether the CSR has an existing relationship with a customer or group of customers. According to embodiments, CSR data 226 further includes CSR profile information, including linked profiles of CSRs, which may be used by validation module 204 to determine whether a CSR has social media or other existing contacts with customers or groups of customers.

Appeasement control data 228 comprises data used by validation module 204 to validate appeasement requests and make validation decisions. For example, appeasement control data 228 may include appeasement history data for one or more customers or customer clusters, which validation module 204 may analyze to determine rates or patterns of customer appeasements for particular customers or groups of customers. Appeasement control data 228 may also include appeasement policies for a particular seller or retailer of supply chain network 100, or for groups of sellers, retailers, or any one or more supply chain entities 140 of supply chain network 100. The appeasement policies may include limits on the values or instances of customer appeasements offered to customers over a period of time, such as an appeasement allowance for a month, quarter, or year, though any other period of time may be used to define appeasement allowances. The appeasement policies may also include limits on the values or instances of customer appeasements that particular CSRs may offer over a period of time. In embodiments, appeasement control data 228 further includes partner data relating to customer orders, such as shipping information, order scan data, and order audit data, when available.

Offers data 230 comprises data detailing one or more appeasement offers. As disclosed above, contextual offers module 206 may generate the one or more appeasement offers based on the context of the situation requiring appeasement, such as details of the order and details of the customer requiring appeasement. Offers data 230 may also include acceptance scores for the one or more appeasement offers corresponding to a predicted likelihood of successful appeasement for a particular appeasement offer. Offers data 230 may be generated by contextual offers module 206 based on customer data 220 and order data 222 and may be used by recommendation module 208 to present one or more appeasement offers to the customer via user interface module 214.

Feedback data 232 comprises feedback and interactions collected by update module 210 in response to generated appeasement offers. Feedback data 232 may include data collected from users of appeasement control system 110, such as a manager or administrator of supply chain network 100 or a particular entity of one or more supply chain entities 140, during an approval process for a potential appeasement offer. Feedback data 232 may also include data collected from customers who have received appeasement offers generated by appeasement control system 110, such as acceptance or rejection of an appeasement offer, requests for updates to an appeasement offer, and comments on the appeasement offer. According to embodiments, feedback data 232 is collected by update module 210 and used in conjunction with reinforcement learning model 234 to update the modules of appeasement control system 110 to improve future performance of generating appeasement offers.

Reinforcement learning model 234 comprises an AI or ML model trained to perform reinforcement learning. In embodiments, reinforcement learning model 234 uses input of feedback data 232, including user feedback and customer feedback, to predict the future likelihood of acceptance for a particular appeasement offer or type of appeasement offer to update prediction models that appeasement control system 110 uses for generating appeasement offers and calculating acceptance scores for appeasement offers.

Recovery data 236 comprises data related to recovering appeasement costs from entities that are responsible for situations requiring appeasement. Recovery data 236 may include a reason for the appeasement situation (e.g., transaction data 270 associated with an order corresponding to the appeasement situation), a cost or value of an applied appeasement, and contracts or details of the relationship between one or more supply chain entities 140 applying appeasement and entities that are responsible for the appeasement situation. Recovery data 236 may be used by recovery module 212 to determine a recovery cost and automatically initiate a recovery process with the entities that are responsible for the appeasement situation.

As discussed above, archiving system 120 comprises server 122 and database 124. Although archiving system 120 is illustrated as comprising a single server 122 and a single database 124, embodiments contemplate any suitable number of servers or databases internal to, or externally coupled with, archiving system 120.

Server 122 of archiving system 120 comprises data retrieval module 240. Although server 122 is illustrated and described as comprising a single data retrieval module 240, embodiments contemplate any suitable number or combination of data retrieval modules located at one or more locations local to, or remote from, archiving system 120, such as on multiple servers or computers 150 at one or more locations in supply chain network 100.

In one embodiment, data retrieval module 240 of archiving system 120 receives historical supply chain data 250 from planning and execution system 130 and one or more supply chain entities 140 and stores received historical supply chain data 250 in archiving system 120 database 124. According to one embodiment, data retrieval module 240 may prepare historical supply chain data 250 for use as training data by checking historical supply chain data 250 for errors and transforming historical supply chain data 250 to normalize, aggregate, and/or rescale historical supply chain data 250 to allow direct comparison of data received from planning and execution system 130, one or more supply chain entities 140, and/or one or more other locations local to, or remote from, archiving system 120. According to embodiments, data retrieval module 240 may receive data from one or more sources external to supply chain network 100, such as, for example, weather data, special events data, social media data, calendar data, and the like, and store the received data as historical supply chain data 250.

Database 124 of archiving system 120 may comprise one or more databases or other data storage arrangements at one or more locations local to, or remote from, server 122. Database 124 of archiving system 120 comprises, for example, historical supply chain data 250. Although database 124 of archiving system 120 is illustrated and described as comprising historical supply chain data 250, embodiments contemplate any suitable number or combination of data located at one or more locations local to, or remote from, archiving system 120, according to particular needs.

Historical supply chain data 250 comprises historical data received from appeasement control system 110, planning and execution system 130, one or more supply chain entities 140, and/or one or more computers 150. Historical supply chain data 250 may comprise, for example, weather data, special events data, social media data, calendar data, and the like. In an embodiment, historical supply chain data 250 may comprise, for example, historic sales patterns, prices, promotions, weather conditions, and other factors influencing future demand of the number of one or more items sold in one or more stores over a time period, such as, for example, one or more days, weeks, months, or years, including, for example, a day of the week, a day of the month, a day of the year, a week of the month, a week of the year, a month of the year, special events, paydays, and the like.

As discussed above, planning and execution system 130 comprises server 132 and database 134. Although planning and execution system 130 is illustrated as comprising a single server 132 and a single database 134, embodiments contemplate any suitable number of servers or databases internal to, or externally coupled with, planning and execution system 130.

In embodiments, server 132 of planning and execution system 130 comprises planning module 260 and prediction module 262. Although server 132 is illustrated and described as comprising a single planning module 260 and a single prediction module 262, embodiments contemplate any suitable number or combination of planning modules and prediction modules located at one or more locations local to, or remote from, planning and execution system 130, such as on multiple servers or computers 150 at one or more locations in supply chain network 100.

Planning module 260 of planning and execution system 130 works in connection with prediction module 262 to generate a plan based on one or more predicted retail volumes, classifications, or other predictions. By way of example and not of limitation, planning module 260 may comprise a demand planner that generates a demand forecast for one or more supply chain entities 140. Planning module 260 may generate the demand forecast, at least in part, from predictions and calculated factor values for one or more causal factors received from prediction module 262. By way of a further example, planning module 260 may comprise an assortment planner and/or a segmentation planner that generates product assortments that match causal effects calculated for one or more customers or products by prediction module 262, which may provide for increased customer satisfaction and sales, as well as reduce costs for shipping and stocking products at stores where they are unlikely to sell.

Prediction module 262 of planning and execution system 130 applies samples of transaction data 270, supply chain data 272, product data 274, inventory data 276, capacity data 278, store data 280, customer data 282, demand forecasts 284, and other data to prediction models 288 to generate predictions and calculated factor values for one or more causal factors. Prediction module 262 of planning and execution system 130 may predict a volume Y (target) from a set of causal factors X along with causal factors strengths that describe the strength of each causal factor variable contributing to the predicted volume. According to some embodiments, prediction module 262 generates predictions at daily intervals. However, embodiments contemplate longer and shorter prediction phases that may be performed, for example, weekly, twice a week, twice a day, hourly, or the like.

Database 134 of planning and execution system 130 may comprise one or more databases or other data storage arrangements at one or more locations local to, or remote from, server 132. Database 134 of planning and execution system 130 comprises, for example, transaction data 270, supply chain data 272, product data 274, inventory data 276, capacity data 278, store data 280, customer data 282, demand forecasts 284, supply chain models 286, and prediction models 288. Although database 134 of planning and execution system 130 is illustrated and described as comprising transaction data 270, supply chain data 272, product data 274, inventory data 276, capacity data 278, store data 280, customer data 282, demand forecasts 284, supply chain models 286, and prediction models 288, embodiments contemplate any suitable number or combination of data located at one or more locations local to, or remote from, planning and execution system 130, according to particular needs.

Transaction data 270 of planning and execution system 130 may comprise recorded sales and returns transactions and related data, including, for example, a transaction identification, time and date stamp, channel identification (such as stores or online touchpoints), product identification, actual cost, selling price, sales volume, customer identification, promotions, and/or the like. In addition, transaction data 270 is represented by any suitable combination of values and dimensions, aggregated or disaggregated, such as, for example, sales per week, sales per week per location, sales per day, sales per day per season, or the like.

Supply chain data 272 may comprise any data of one or more supply chain entities 140 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 140.

Product data 274 of database 134 may comprise products identified by, for example, a product identifier (such as a Stock Keeping Unit (SKU), Universal Product Code (UPC), or the like) and one or more attributes and attribute types associated with the product ID. Product data 274 may comprise data about one or more products organized and sortable by, for example, product attributes, attribute values, product identification, product components, sales volume, demand forecast, or any stored category or dimension. Attributes of one or more products may be, for example, any categorical characteristic, structural characteristic, or quality of a product, and an attribute value may be a specific value or identity for the one or more products according to the categorical characteristic or quality, including, for example, physical parameters (such as, for example, size, weight, dimensions, color, and the like).

Inventory data 276 of database 134 may comprise any data relating to current or projected inventory quantities or states, order rules, or the like. For example, inventory data 276 may comprise the current level of inventory for each item at one or more stocking points across supply chain network 100. In addition, inventory data 276 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 130 accesses and stores inventory data 276 in database 134, which may be used by planning and execution system 130 to place orders, set inventory levels at one or more stocking points, initiate manufacturing of one or more components, or the like.

In embodiments, inventory data 276 may also comprise one or more inventory policies. The inventory policies may comprise any suitable inventory policy describing the reorder point and target quantity, or other inventory policy parameters that set rules for planning and execution system 130 to manage and reorder inventory. The inventory policies may be based on target service level, demand, cost, fill rate, or the like. According to embodiments, the inventory policies comprise target service levels that ensure that a service level of one or more supply chain entities 140 is met with a set probability. For example, one or more supply chain entities 140 may set a service level at 95%, meaning one or more supply chain entities 140 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 130 may determine a replenishment order according to one or more replenishment rules, which, among other things, indicates to one or more supply chain entities 140 to determine or receive inventory to replace the depleted inventory. By way of example only and not by way of limitation, an inventory policy for non-perishable goods with linear holding and shorting costs comprises a min./max. (s,S) inventory policy. Other inventory policies may be used for perishable goods, such as fruit, vegetables, dairy, and fresh meat, as well as electronics, fashion, and similar items for which demand drops significantly after a next generation of electronic devices or a new season of fashion is released.

Capacity data 278 of database 134 may comprise any data relating to current or projected resource capacity values or states, order rules, or the like. For example, capacity data 278 may comprise the current level of capacity for each task at one or more locations across supply chain network 100. In addition, capacity data 278 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 130 accesses and stores capacity data 278 in database 134, which may be used by planning and execution system 130 to place orders, set capacity levels at one or more locations in supply chain network 100, initiate manufacturing of one or more components, or the like.

In embodiments, capacity data 278 may include one or more capacity policies. The capacity policies may comprise any suitable capacity policy describing the reorder point and target quantity, or other capacity policy parameters that set rules for planning and execution system 130 to manage capacity. The capacity policies may be based on target service level, demand, cost, or the like. According to embodiments, the capacity policies comprise target service levels that ensure that a service level of one or more supply chain entities 140 is met with a set probability. For example, one or more supply chain entities 140 may set a service level at 95%, meaning one or more supply chain entities 140 sets the desired capacity level at a level that meets demand 95% of the time.

Store data 280 may comprise data describing the stores of one or more retailers and related store information. Store data 280 may comprise, for example, a store ID, store description, store location details, store location climate, store type, store opening date, lifestyle, store area (expressed in, for example, square feet, square meters, or other suitable measurement), latitude, longitude, and other similar data.

Customer data 282 of planning and execution system 130 may comprise customer identity information, including, for example, customer relationship management data, loyalty programs, and mappings between product purchases and one or more customers so that a customer associated with a transaction may be identified. Customer data 282 may further comprise data relating customer purchases to one or more products, geographical regions, store locations, or other types of dimensions. In an embodiment, customer data 282 may also comprise customer profile information, including demographic information and preferences.

Demand forecasts 284 of database 134 may indicate expected future demand based on, for example, any data relating to past sales, past demand, purchase data, promotions, events, or the like of one or more supply chain entities 140. Demand forecasts 284 may cover a time interval such as, for example, by the minute, by the hour, daily, weekly, monthly, quarterly, yearly, or any other suitable time interval, including substantially in real time. In some embodiments, demand may be modeled as a negative binomial or Poisson-Gamma distribution. According to other embodiments, the model also takes into account shelf-life of perishable goods (which may range from days (e.g., fresh fish or meat) to weeks (e.g., butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. By way of example only and not by way of limitation, an exemplary supermarket may stock twenty thousand items at one thousand locations. When each location of this exemplary supermarket is open every day of the year, planning and execution system 130 needs to calculate approximately 2×10\hat{ }10 demand forecasts 284 each day to derive the optimal order volume for the next delivery cycle (e.g., three days).

Supply chain models 286 of database 134 comprise characteristics of a supply chain setup to deliver the customer expectations of a particular customer business model. These characteristics may comprise differentiating factors, such as, for example, MTO (Make-to-Order), ETO (Engineer-to-Order), or MTS (Make-to-Stock). However, supply chain models 286 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for by particular customers. Each of these characteristics may lead to a different supply chain model. Prediction models 288 comprise one or more of the trained models used by planning and execution system 130 for predicting, among other variables, pricing, targeting, or retail volume, such as, for example, a forecasted demand volume for one or more products at one or more stores of one or more retailers based on the prices of the one or more products.

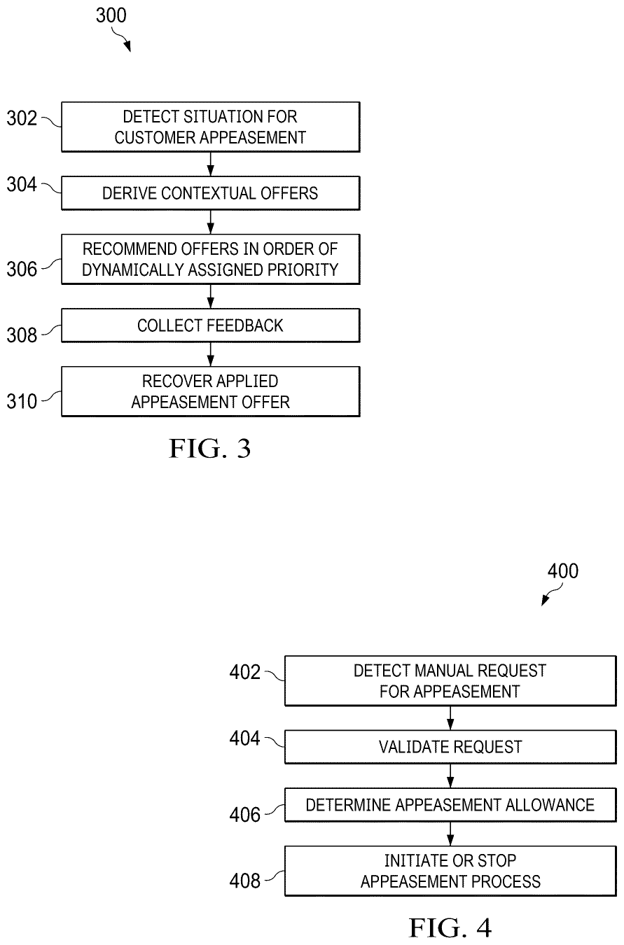

FIG. 3 illustrates method 300 for generating and presenting appeasement offers to customers of supply chain network 100, in accordance with an embodiment. Method 300 may be performed by an appeasement control system, such as appeasement control system 110 of FIG. 1. Method 300 proceeds by one or more activities, which although described in a particular order, may be performed in one or more permutations, combinations, orders, or repetitions, according to particular needs.

At activity 302, detection module 202 of appeasement control system 110 detects a situation requiring customer appeasement. The situation may include, for example, an order delivered in damaged or unusable condition, an order delivered later than a promised delivery date, a negative customer service interaction which has left a customer dissatisfied, or any other situation resulting in customer dissatisfaction which may result in loss of the customer or loss of sales. In embodiments, to detect the situation requiring customer appeasement, detection module 202 may track interactions between a customer and customer service representatives, customer service channels, self-service channels, or any other communications channels between the customer and a seller of supply chain network 100. Detection module 202 may further analyze the tracked activities and interactions to detect that the customer in dissatisfied and derive an associated appeasement reason or a cause of the customer dissatisfaction.

At activity 304, contextual offers module 206 of appeasement control system 110 derives one or more contextual appeasement offers to present to the customer. To personalize the one or more contextual appeasement offers, contextual offers module 206 may tailor the one or more appeasement offers to the particular needs or preferences of the customer. In embodiments, contextual offers module 206 mines data around a recent order of a customer or an order corresponding to an appeasement situation, as well as an order history of the customer, to derive the one or more contextual appeasement offers. Contextual offers module 206 may further analyze the mined data, such as, for example, data including purchase history data of the customer, customer profile data of the customer, customer preference data, and cluster data associated with a customer cluster, including the customer and predicted future orders of the customer, to determine the customer value of the customer. Contextual offers module 206 may then generate the set of contextual appeasement offers for the customer based on the determined customer value. In embodiments, contextual offers module 206 also generates a rationale or explanation for each generated contextual appeasement offer.

At activity 306, recommendation module 208 of appeasement control system 110 recommends one or more appeasement offers in order of a dynamically assigned priority. According to embodiments, recommendation module 208 dynamically calculates an acceptance score representing the likelihood of the appeasement offer resolving the appeasement situation for each of the one or more appeasement offers. Recommendation module 208 may calculate the acceptance scores based on an appeasement history of similar offers in similar situations and similar offers to similar customers and/or based on appeasement history of the customer when the customer has an appeasement history. In embodiments, recommendation module 208 determines whether approval is required for any of the one or more appeasement offers by comparing the acceptance scores to a configured approval threshold. Recommendation module 208 may further present the approved appeasement offers to the customer in order of the calculated acceptance scores via user interface module 214.

At activity 308, update module 210 of appeasement control system 110 collects feedback to use to improve future output of appeasement control system 110. Update module 210 may use the collected feedback in a reinforcement learning process, such as, for example, via reinforcement learning model 234, to improve the quality of appeasement offers generated for customers and improve the accuracy of acceptance scores calculated for appeasement offers. In embodiments, to collect the feedback, update module 210 tracks updates made to an appeasement offer during approval by a user of appeasement control system 110, such as a manager or administrator of appeasement control system 110 or a supply chain planner or retailer manager of supply chain network 100. Update module 210 may also track reactions of the customer to the appeasement offer, such as whether the customer accepts or rejects the appeasement offer. According to embodiments, update module 210 further provides the collected feedback to reinforcement learning model 234 to perform reinforcement learning to update one or more modules of appeasement control system 110.

At activity 310, recovery module 212 of appeasement control system 110 recovers an amount of an applied appeasement offer from an entity responsible for the appeasement situation. Recovery module 212 may determine the recovery amount based on a total value of the appeasement, such as when an appeasement offer includes a discount on a recurring basis, or any other calculated recovery value. According to embodiments, to recover the applied appeasement offer, recovery module 212 determines the responsible entity based, at least in part, on the appeasement reason derived at activity 302. For example, when warehouse photo data indicates that a particular order left a seller warehouse in good condition but was delivered damaged, recovery module 212 may determine that the entity that is responsible for delivery to the customer is responsible for the appeasement situation. Recovery module 212 may also determine the recovery amount associated with the applied appeasement offer and automatically initiate a recovery process with the responsible entity based on the determined recovery amount.

FIG. 4 illustrates method 400 for generating appeasement offers based on validated appeasement requests, in accordance with an embodiment. Method 400 may be performed by an appeasement control system, such as appeasement control system 110 of FIG. 1. Method 400 proceeds by one or more activities, which although described in a particular order, may be performed in one or more permutations, combinations, orders, or repetitions, according to particular needs.

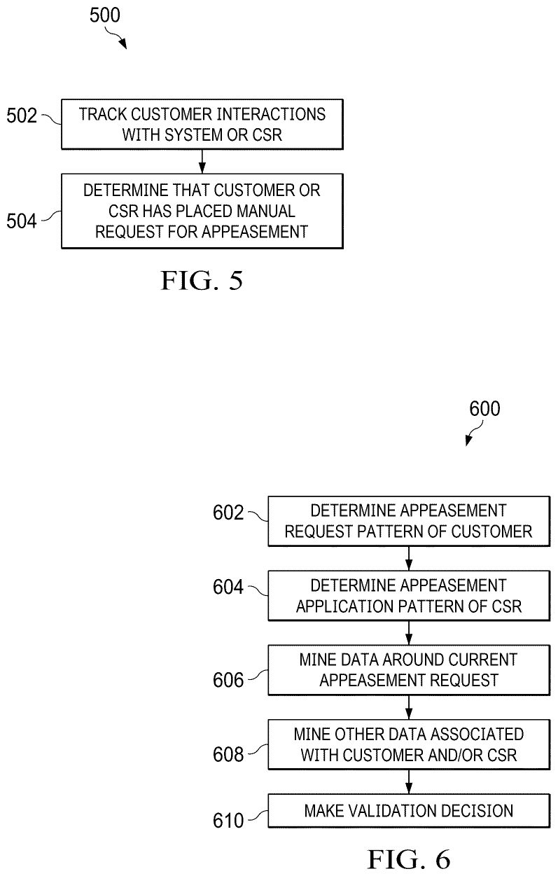

At activity 402, detection module 202 of appeasement control system 110 detects a manual request for appeasement submitted by a customer or a CSR of supply chain network 100. By way of example only and not by way of limitation, a retailer of supply chain network 100 may provide a mobile app that enables customers to report order damage or other problems with an order, and appeasement control system 110 may be configured to receive the order problem reports. In other examples, detection module 202 may detect a manual request for appeasement via a website, via customer service, or any other method enabling customers to report order problems and request appeasements. In addition, or as an alternative, detection module 202 may detect appeasement situations without a manual request for appeasement, such as by analyzing order data 222 associated with an order or IoT data associated with ordered products indicating damage to an order that has not been reported by a customer. According to embodiments, appeasement control system 110 performs method 500 described below with respect to FIG. 5 (or a method substantially similar to method 500) to detect the manual request for appeasement.

At activity 404, validation module 204 of appeasement control system 110 validates the manual request for appeasement detected at activity 402. Validating appeasement requests may enable appeasement control system 110 to limit customer appeasements offered to customers in situations where appeasement may not be necessary or desirable, such as situations of the customer abusing an appeasement process or policy of a retailer. According to embodiments, appeasement control system 110 performs method 600 described below with respect to FIG. 6 (or a method substantially similar to method 600) to validate appeasement requests.

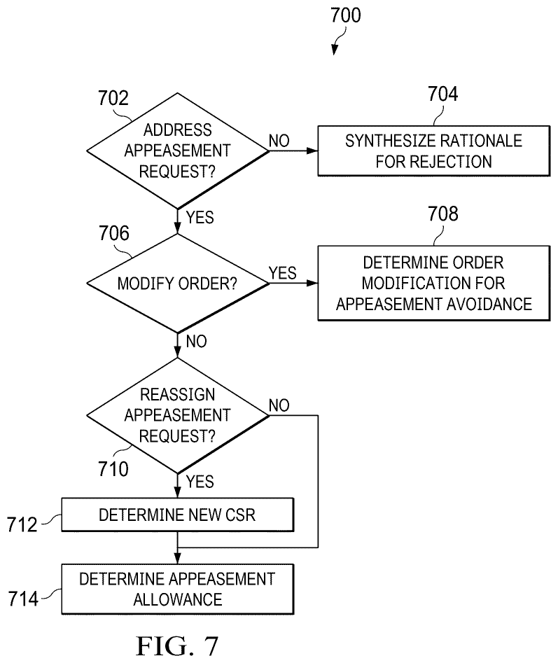

At activity 406, validation module 204 determines an appeasement allowance for the appeasement request based on the validation performed at activity 404. For example, validation module 204 may determine to limit the value of appeasements offered in response to the request based on an appeasement history of the customer or an appeasement history of a CSR assigned to the request. In some embodiments, validation module 204 may determine non-appeasement options to recommend instead of an appeasement process, such as, for example, recommending order modifications or recommending reassigning the CSR assigned to the request. According to embodiments, appeasement control system 110 performs method 700 described below with respect to FIG. 7 (or a method substantially similar to method 700) to determine the appeasement allowance.

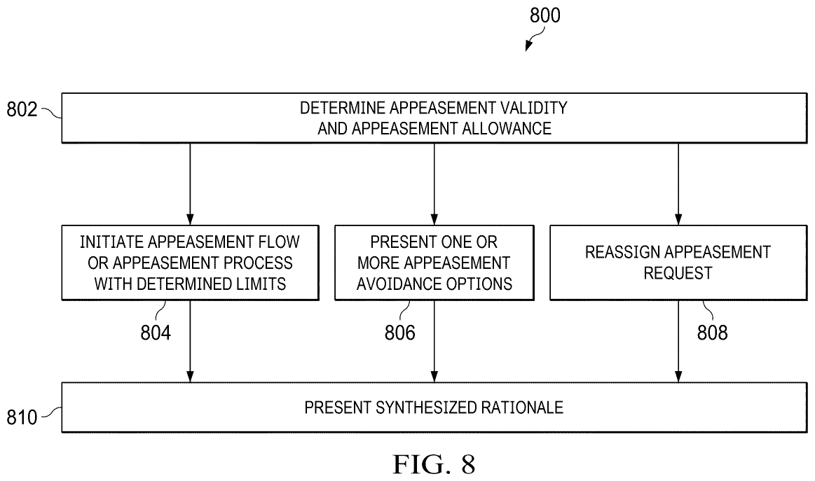

At activity 408, recommendation module 208 of appeasement control system 110 initiates an appeasement process for the request based on the appeasement allowance determined at activity 406. In addition, or as an alternative, recommendation module 208 may stop an in-progress appeasement process based on the allowance determined at activity 406. When validation module 204 determines one or more non-appeasement options at activity 406, recommendation module 208 may initiate the recommended non-appeasement option at activity 408, such as after stopping an in-progress appeasement process. According to embodiments, appeasement control system 110 may perform method 800 described below with respect to FIG. 8 (or a method substantially similar to method 800) to initiate the appeasement process.

FIG. 5 illustrates example method 500 for detecting appeasement requests, in accordance with an embodiment. Method 500 may be performed by an appeasement control system, such as appeasement control system 110 of FIG. 1. Method 500 proceeds by one or more activities, which although described in a particular order, may be performed in one or more permutations, combinations, orders, or repetitions, according to particular needs.

At activity 502, detection module 202 of appeasement control system 110 tracks interactions between a customer of supply chain network 100 and a device or system associated with a seller or retailer of supply chain network 100, or between the customer and a CSR associated with the seller. Detection module 202 may monitor various communication channels between the seller and the retailer, including call centers, in-person interactions between customers and representatives of the seller, website or app interactions between the customer and representatives of the seller, and/or social media interactions between the customer and representatives of the seller.

At activity 504, detection module 202 determines, based on interactions monitored at the first activity, that either the customer or a CSR assigned to a particular customer or customer order has placed a manual request for customer appeasement, such as an appeasement for an order problem or any other situation resulting in reported customer dissatisfaction. Detection module 202 may determine that a request for appeasement has been placed by receiving a configured appeasement request via a dedicated appeasement request channel within supply chain network 100 and/or by analyzing UI actions associated with the customer or the CSR, such as keyboard input, mouse input, voice input or voice utterances, command data, gesture data (e.g., from one or more imaging devices), interactions with virtual assistants, or any other UI actions. In embodiments, upon determining that a request for appeasement has been placed, appeasement control system 110 may imitate a process for validating the appeasement request, such as, for example, via method 600 described below with respect to FIG. 6.

FIG. 6 illustrates example method 600 for validating appeasement requests, in accordance with an embodiment. Method 600 may be performed by an appeasement control system, such as appeasement control system 110 of FIG. 1. Method 600 proceeds by one or more activities, which although described in a particular order, may be performed in one or more permutations, combinations, orders, or repetitions, according to particular needs.

At activity 602, validation module 204 of appeasement control system 110 determines an appeasement request pattern for a customer of supply chain network 100 that has placed an appeasement request based on an appeasement history of the customer. At activity 604, validation module 204 determines an appeasement application pattern for a CSR assigned to the customer or assigned to an order of the customer associated with the appeasement request based on a history of appeasements offered to customers by the CSR.

At activity 606, validation module 204 mines various data around the appeasement request, such as an appeasement reason entered by the customer or the CSR and data related to the order of the customer or a partner associated with the order, such as shipping data or audit data. For example, when the appeasement reason is “late delivery,” but the partner shipping data shows an on-time delivery with photo proof, validation module 204 may determine that the appeasement request is not genuine.

At activity 608, validation module 204 mines any available other data associated with the customer or the CSR apart from the appeasement histories analyzed at activities 602-606, such as messages between the customer and the CSR, profile information of the customer and of the CSR, and appeasement history data for customer clusters or segments that include the customer. For example, when validation module 204 determines that a CSR is friends with a group of customers by analyzing social media data, and the appeasement history for the CSR indicates approval of all appeasement requests from the group of customers, validation module 204 may determine that appeasement requests from the group of customers processed by the CSR may not be genuine and recommend reassigning such appeasement requests to other representatives.

At activity 610, validation module 204 makes a validation decision for the appeasement request. Validation module 204 may use the data mined at activities 606-608 to make the validation decision and, based on the validation decision, determine how to process the appeasement request. In embodiments, appeasement control system 110 determines how to process the appeasement request by applying an appeasement allowance using method 700 described below with respect to FIG. 7.

FIG. 7 illustrates example method 700 for determining an appeasement allowance, in accordance with an embodiment. Method 700 may be performed by an appeasement control system, such as appeasement control system 110 of FIG. 1. Method 700 proceeds by one or more activities, which although described in a particular order, may be performed in one or more permutations, combinations, orders, or repetitions, according to particular needs.

At activity 702, validation module 204 of appeasement control system 110 determines whether to address an appeasement request received in relation to a particular customer of supply chain network 100. In embodiments, validation module 204 determines whether to address the appeasement request by validating the appeasement request, such as by comparing the appeasement request to data available to appeasement control system 110, as described in greater detail above with respect to FIG. 6.

When validation module 204 determines not to address the appeasement request, at activity 704, validation module 204 synthesizes a rationale for rejection of the appeasement request and method 700 ends. In embodiments, user interface module 214 of appeasement control system 110 transmits the rejection and rationale to the customer. For example, when validation module 204 determines that a customer appeasement request is not genuine, validation module 204 may synthesize a rationale explaining the discrepancy in the information provided by the customer and the information available to appeasement control system 110, and user interface module 214 may present the rationale to the customer via an output device associated with the customer. According to embodiments, validation module 204 utilizes one or more NLP techniques to synthesize the rationale in natural language, such as the native language of the customer or the default language used in supply chain network 100.

When, at activity 702, validation module 204 determines to address the appeasement request, validation module 204 determines whether to address the appeasement request through order modifications at activity 706. For example, when the customer has a high rate of requesting appeasements in the past, but the current appeasement request appears genuine, validation module 204 may recommend non-appeasement options to address the appeasement situation.

When validation module 204 determines to address the appeasement request through order modifications, at activity 708, recommendation module 208 of appeasement control system 110 determines one or more order modifications to use for appeasement avoidance, and method 700 ends. In addition, validation module 204 may synthesize a rationale for the one or more order modifications based on the validation decision and present the rationale to the customer via user interface module 214. As an example of determining one or more order modifications, recommendation module 208 may recommend an order modification, such as canceling and refunding the order, rather than an appeasement offer, such as a future discount or promotional item as an appeasement. This may be beneficial when, for example, the value of a future discount provided as an appeasement is greater than the value of the initial order of the appeasement situation. According to embodiments, recommendation module 208 makes order modification recommendations that adhere to an appeasement policy or process of supply chain network 100 or a particular seller or retailer of supply chain network 100.

When, at activity 706, validation module 204 determines not to address the appeasement request through order modifications, validation module 204 determines whether to reassign the appeasement request from a CSR currently assigned to the appeasement request to another CSR. For example, validation module 204 may analyze appeasement history of the customer and the CSR to determine whether the CSR approves a large number of appeasements for the customer and thus whether the CSR has a relationship with the customer outside of the business relationship. When validation module 204 determines to reassign the appeasement request, at activity 712, validation module 204 determines a new CSR whom which to reassign the appeasement request based on the appeasement history of the customer and of the CSR to be reassigned.

When, at activity 710, validation module 204 determines not to reassign the appeasement request, or after reassigning the appeasement request at activity 712, recommendation module 208 generates an appeasement offer limited to an appeasement amount for the appeasement request at activity 714. Validation module 204 may also synthesize a rationale for the appeasement allowance. In embodiments, recommendation module 208 utilizes various customer data 220, such as a purchase history of the customer, profile information of the customer, and the like, as well as an appeasement policy of the seller or of supply chain network 100 to generate the appeasement offer and appeasement amount, as discussed in greater detail above with respect to FIG. 3.

FIG. 8 illustrates example method 800 for presenting responses to appeasement requests, in accordance with an embodiment. Method 800 may be performed by an appeasement control system, such as appeasement control system 110 of FIG. 1. Method 800 proceeds by one or more activities, which although described in a particular order, may be performed in one or more permutations, combinations, orders, or repetitions, according to particular needs.

At activity 802, validation module 204 of appeasement control system 110 determines the validity of, and an appeasement allowance for, an appeasement request placed by a customer or a CSR of supply chain network 100. According to embodiments, appeasement control system 110 may perform method 600 described above with respect to FIG. 6 and/or method 700 described above with respect to FIG. 7 to determine the appeasement validity and the appeasement allowance.

At activity 804, recommendation module 208 of appeasement control system 110 initiates an appeasement flow or appeasement process with determined limits for the customer who has requested appeasement. For example, validation module 204 may determine to set an appeasement allowance for the customer based on the appeasement history of the customer, which may be a limit on the value of individual appeasement offers, a limit on appeasement value across a specified time frame, or any other limit on the possible appeasement offers presented to the customer.

At activity 806, recommendation module 208 presents one or more appeasement avoidance options to a user of appeasement control system 110 or to the customer via user interface module 214 of appeasement control system 110. For example, may recommend to a user of appeasement control system 110 to offer the customer an order cancellation and refund rather than a typical or traditional appeasement. In other embodiments, recommendation module 208 may generate one or more appeasement avoidance options and present the one or more appeasement avoidance options to the customer.

At activity 808, validation module 204 reassigns the appeasement request from a CSR initially associated with the appeasement request to a different CSR, agent, or representative. For example, when the customer has an extensive appeasement history and the CSR initially assigned to the request has a high approval rate for appeasement requests, validation module 204 may reassign the appeasement request to a different CSR with a lower appeasement request approval rate.

At activity 810, user interface module 214 presents a synthesized rationale to the customer or a user of appeasement control system 110. User interface module 214 may present the rationale to the customer or the user in relation to any or all of activities 804-808. For example, when validation module 204 reassigns the appeasement request to a new CSR at activity 808, validation module 204 may synthesize a rationale explaining the reassignment decision and present the synthesized rationale via user interface module 214 to the initially assigned CSR and/or the customer, depending on the intended audience for the rationale at the time of synthesis.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for validating an appeasement request, comprising:
a computer, comprising a processor and a memory, the computer configured to:
determine an appeasement request pattern for a customer;
determine an appeasement application pattern for a customer service representatives assigned to the customer;
mine data associated with the appeasement request;
mine other data associated with the customer or the customer service representatives; and
validate an appeasement request based on the mined data and the mined other data.

2. The system of claim 1, wherein the data associated with the appeasement request comprises one or more of: an appeasement reason, order data, shipping data and audit data.

3. The system of claim 1, wherein the other data associated with the customer or the customer service representatives comprises one or more of: one or more messages between the customer and the customer service representatives, profile information of the customer, profile information of the customer service representatives, and appeasement history data for customer segments that include the customer.

4. The system of claim 1, wherein validating the appeasement request further comprises determining an appeasement allowance.

5. The system of claim 1, wherein the computer is further configured to:
determine that an association between the customer service representatives and a group of customers indicates one or more fraudulent appeasement requests.

6. The system of claim 1, wherein the appeasement application pattern is based, at least in part, on a history of appeasements offered to one or more customers.

7. The system of claim 1, wherein validating the appeasement request further comprises limiting an appeasement offer associated with the appeasement request.

8. A computer-implemented method for validating an appeasement request, comprising:
determining, by a computer comprising a processor and a memory, an appeasement request pattern for a customer;
determining, by the computer, an appeasement application pattern for a customer service representatives assigned to the customer;
mining, by the computer, data associated with the appeasement request;
mining, by the computer, other data associated with the customer or the customer service representatives; and
validating, by the computer, an appeasement request based on the mined data and the mined other data.

9. The computer-implemented method of claim 8, wherein the data associated with the appeasement request comprises one or more of: an appeasement reason, order data, shipping data and audit data.

10. The computer-implemented method of claim 8, wherein the other data associated with the customer or the customer service representatives comprises one or more of: one or more messages between the customer and the customer service representatives, profile information of the customer, profile information of the customer service representatives, and appeasement history data for customer segments that include the customer.

11. The computer-implemented method of claim 8, wherein validating the appeasement request further comprises determining an appeasement allowance.

12. The computer-implemented method of claim 8, further comprising:
determining, by the computer, that an association between the customer service representatives and a group of customers indicates one or more fraudulent appeasement requests.

13. The computer-implemented method of claim 8, wherein the appeasement application pattern is based, at least in part, on a history of appeasements offered to one or more customers.

14. The computer-implemented method of claim 8, wherein validating the appeasement request further comprises limiting an appeasement offer associated with the appeasement request.

15. A non-transitory computer-readable medium embodied with software for validating an appeasement request, the software when executed is configured to:
determine, by a computer comprising a processor and a memory, an appeasement request pattern for a customer;
determine an appeasement application pattern for a customer service representatives assigned to the customer;
mine data associated with the appeasement request;
mine other data associated with the customer or the customer service representatives; and
validate an appeasement request based on the mined data and the mined other data.

16. The non-transitory computer-readable medium of claim 15, wherein the data associated with the appeasement request comprises one or more of: an appeasement reason, order data, shipping data and audit data.

17. The non-transitory computer-readable medium of claim 15, wherein the other data associated with the customer or the customer service representatives comprises one or more of: one or more messages between the customer and the customer service representatives, profile information of the customer, profile information of the customer service representatives, and appeasement history data for customer segments that include the customer.

18. The non-transitory computer-readable medium of claim 15, wherein validating the appeasement request further comprises determining an appeasement allowance.

19. The non-transitory computer-readable medium of claim 15, wherein the software when executed is further configured to:
determine that an association between the customer service representatives and a group of customers indicates one or more fraudulent appeasement requests.

20. The non-transitory computer-readable medium of claim 15, wherein the appeasement application pattern is based, at least in part, on a history of appeasements offered to one or more customers.
